(19) United States
(12) Patent Application Publication
(10) Pub. No.: US 2008/0291587 A1
(43) Pub. Date: Nov. 27, 2008

(54) ELECTRONIC APPLIANCE

(76) Inventor: Tsutomu DAIKAWA, Kanagawa (JP)

Correspondence Address: MCDERMOTT WILL & EMERY LLP, 600 13TH STREET, NW, WASHINGTON, DC, 20005-3096, US

(21) Appl. No.: 12/190,964

(22) Filed: Aug. 13, 2008

(30) Foreign Application Priority Data
Mar. 20, 2007 (JP) P.2007-072469

(51) Int. Cl. H02H 3/033

(52) U.S. Cl. 361/1

(57) ABSTRACT

An electronic appliance having a plurality of components is equipped with: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; and a fail-safe circuit for stopping operation of the second component.

### BACKGROUND OF THE INVENTION

1. Field of the Invention

The present invention is related to an electronic appliance which is equipped with a component whose failure may be directly coupled to a risk with respect to a safe aspect of the electronic appliance, and another component, while even when the last-mentioned component fails, although this failure does not give an adverse influence to safety of the electronic appliance, the failure of this component causes the electronic appliance to lose a major function thereof.

2. Description of the Related Art

FIG. 12 is a block diagram for showing a conventional product 100 having a fail-safe function. The product 100 indicated in FIG. 12 is equipped with such a component 110 that contains a time measuring unit 120, a sequencer 130, and a storage unit 140. The component 110 provided in the product 100 has the fail-safe function. An arbitrary time is set to the storage unit 140. While the time measuring unit 120 performs a count-up operation, when a predetermined time that has been set to the storage unit 140 has elapsed, the time measuring unit 120 stops the sequencer 130. The safety of a lifetime end can be improved in the above-described manner (refer to, for example, patent publication 1).

Patent Publication 1: JP-A-7-049151

In the product 100 shown in FIG. 12, when the arbitrarily set predetermined time has elapsed, the operation of the component 110 is automatically stopped so as to improve the safety of the lifetime end. It should be understood that normally, while a product is equipped with large sorts and various modes of components, levels of failures caused by deteriorations, which may give adverse influences to risks for safe aspects of the products, are different from each other, depending upon the components. In other words, there are such components that even when these components fail, the failures thereof may not give any adverse influence to major operations and safety of products, whereas there are such components that if these components fail, then the failures thereof may largely give adverse influences to operations and safety of products. Also, even when components fail, although no adverse influences may be given to safety of components, adverse influences may be given to operations of products.

### SUMMARY OF THE INVENTION

An object of the present invention is to provide an electronic appliance capable of furthermore improving safety thereof when a lifetime of the electronic appliance is ended.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; and a fail-safe circuit for stopping operation of the second component.

In the above-described electronic appliance, the fail-safe circuit is provided within the second component.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; a power supply circuit for controlling a supply of electric power to the second component; and a fail-safe circuit operated in such a manner that while the fail-safe circuit monitors a status of the first component, when the fail-safe circuit detects a problem of the first component, the fail-safe circuit controls the power supply circuit so as to stop the supply of the electric power to the second component.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; a clock control circuit for controlling a clock signal supplied to the second component; and a fail-safe circuit operated in such a manner that while the fail-safe circuit monitors a status of the first component, when the fail-safe circuit detects a problem of the first component, the fail-safe circuit controls the clock control circuit so as to stop the supply of the clock signal to the second component.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; a reset control circuit for resetting the second component; and a fail-safe circuit operated in such a manner that while the fail-safe circuit monitors a status of the first component, when said fail-safe circuit detects a problem of said first component, the fail-safe circuit controls the reset control circuit in order that the second component is kept under a resetting condition thereof.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; a data line control circuit for controlling a data line of the second component; and a fail-safe circuit operated in such a manner that while the fail-safe circuit monitors a status of the first component, when the fail-safe circuit detects a problem of the first component, the fail-safe circuit controls the data line control circuit in order that the data line of the second component is brought into an uncontrolled condition.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; a control line control circuit for controlling a control line of the second component; and a fail-safe circuit operated in such a manner that while the fail-safe circuit monitors a status of the first component, when the fail-safe circuit detects a problem of said first component, the fail-safe circuit controls the control line control circuit in order that the control line of the second component is brought into an uncontrolled condition.

The present invention is to provide such an electronic appliance featured by that in an electronic appliance having a plurality of components, the electronic appliance is comprised of: a first component whose failure is directly coupled to a risk with respect to a safe aspect of the electronic appliance; a second component by which even when the second component fails, although the failure of the second component does not give an adverse influence to safety of the electronic appliance, the failure of the second component causes the electronic appliance to lose a major function thereof; an address line control circuit for controlling an address line of the second component; and a fail-safe circuit operated in such a manner that while the fail-safe circuit monitors a status of the first component, when the fail-safe circuit detects a problem of the first component, the fail-safe circuit controls the address line control circuit in order that the address line of the second component is brought into an uncontrolled condition.

In the above-described electronic appliance, when the fail-safe circuit detects a status of the first component in response to a signal transmitted from an external appliance and detects a problem of the first component, the fail-safe circuit stops the operation of the second component.

In the above-described electronic appliance, after the fail-safe circuit has detected the problem of the first component, when the fail-safe circuit receives an instruction signal for stopping the operation of the second component transmitted from the external appliance, the fail-safe circuit stops the operation of the second component.

In the above-described electronic appliance, the signal transmitted from the external appliance is a signal transferred therefrom via a network.

In the above-described electronic appliance, when a predetermined time has elapsed from a time indicated by time information related to a purchase of the electronic appliance, or an initial operation of the electronic appliance, the fail-safe circuit stops the operation of the second component.

In the above-described electronic appliance, after the predetermined time has passed, when the fail-safe circuit receives an instruction signal for stopping the operation of the second component transmitted from an external appliance, the fail-safe circuit stops the operation of the second component.

In the above-described electronic appliance, the external appliance is a recharging device of the electronic appliance.

In accordance with the electronic appliance related to the present invention, the safety thereof when the lifetime is ended can be furthermore improved. In other words, the end of lifetime as the product can be reached in a safer manner.

### BRIEF DESCRIPTION OF THE DRAWINGS

FIG. 1 is a block diagram for showing a product having a fail-safe function, according to a first embodiment mode of the present invention.

FIG. 2 is a block diagram for indicating a product having a fail-safe function, according to a second embodiment mode of the present invention.

FIG. 3 is a block diagram for showing a product having a fail-safe function, according to a third embodiment mode of the present invention.

FIG. 4 is a block diagram for indicating a product having a fail-safe function, according to a fourth embodiment mode of the present invention.

FIG. 5 is a block diagram for showing a product having a fail-safe function, according to a fifth embodiment mode of the present invention.

FIG. 6 is a block diagram for indicating a product having a fail-safe function, according to a sixth embodiment mode of the present invention.

FIG. 7 is a block diagram for showing a product having a fail-safe function, according to a seventh embodiment mode of the present invention.

FIG. 8 is a block diagram for indicating a product having a fail-safe function, according to an eighth embodiment mode of the present invention.

FIG. 9 is a block diagram for showing a product having a fail-safe function, according to a ninth embodiment mode of the present invention.

FIG. 10 is a block diagram for indicating a product having a fail-safe function, according to a tenth embodiment mode of the present invention.

FIG. 11 is a block diagram for showing a product having a fail-safe function, according to an eleventh embodiment mode of the present invention.

FIG. 12 is a block diagram for indicating the product having the fail-safe function, according to the conventional technique.

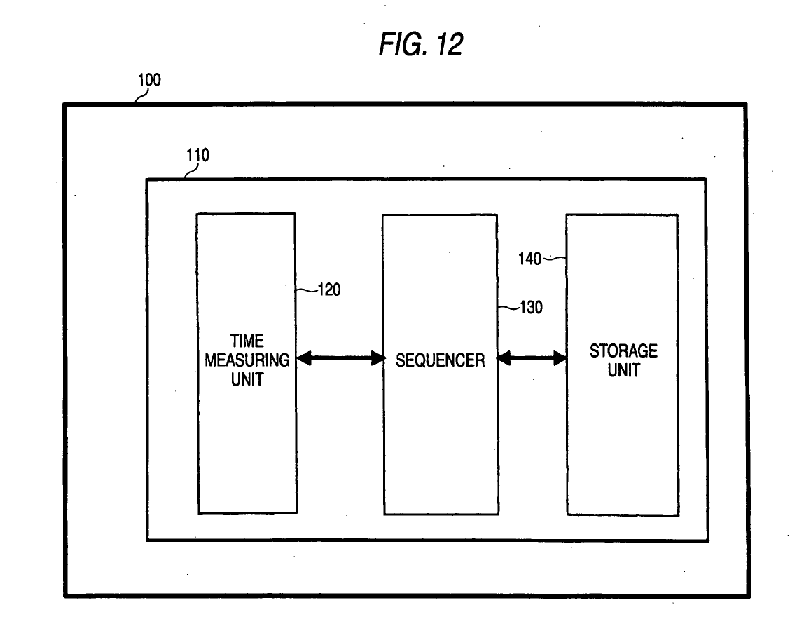

### DESCRIPTION OF THE PREFERRED EMBODIMENTS

Referring now to drawings, a description is made of embodiment modes of the present invention.

### First Embodiment Mode

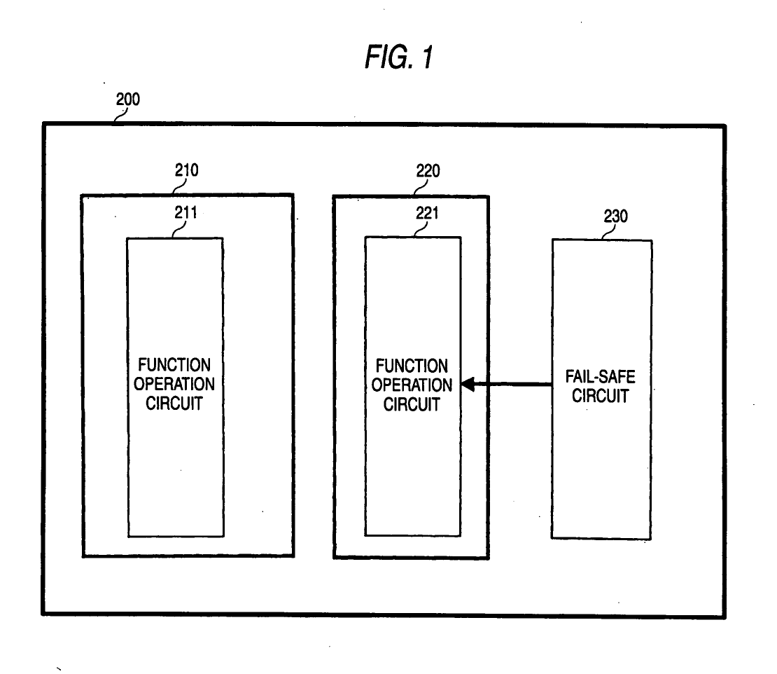

FIG. 1 is a block diagram for indicating a product having a fail-safe function, according to a first embodiment mode of the present invention. The product 200 shown in FIG. 1 is equipped with a component 210 having a function operation circuit 211, a component 220 having a function operation circuit 221, and a fail-safe circuit 230.

The component 210 corresponds to such a component whose failure may be directly coupled to a risk as to a safe aspect of the product 200. The component 220 is such a component that even when the component 220 fails, although this failure does not give an adverse influence to safety of the product 200, the failure of the component 220 causes the product 200 to loss a major function thereof. The function operation circuit 211 corresponds to such a circuit which is required for executing a function of the product 200 realized by the component 220. The function operation circuit 221 corresponds to such a circuit which is required for executing a function of the product 200 realized by the component 220. The fail-safe circuit 230 corresponds to such a circuit which stops operation of the function operation circuit 221.

In the first embodiment mode, since the fail-safe circuit 230 is mounted outside the components 210 and 220, the fail-safe circuit 230 can be mounted on any positions within the product 200.

### Second Embodiment Mode

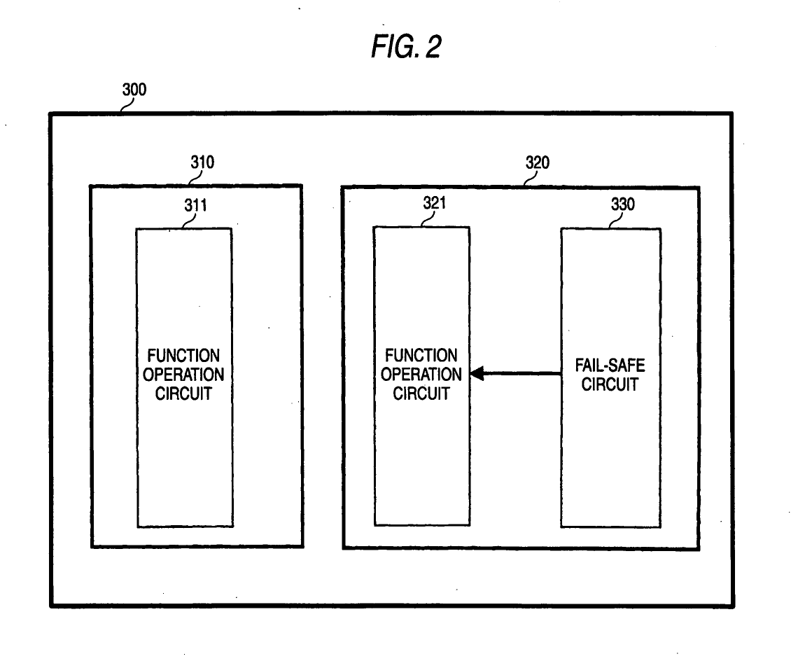

FIG. 2 is a block diagram for indicating a product having a fail-safe function, according to a second embodiment mode of the present invention. The product 300 shown in FIG. 2 is equipped with a component 310 having a function operation circuit 311, and another component 320 having a function operation circuit 321 and also a fail-safe circuit 330.

The component 310 corresponds to such a component whose failure may be directly coupled to a risk as to a safe aspect of the product 300. The component 320 is such a component that even when the component 320 fails, although this failure does not give an adverse influence to safety of the product 300, the failure of the component 320 causes the product 300 to lose a major function thereof. The function operation circuit 311 corresponds to such a circuit that is required for executing a function of the product 300 realized by the component 310. The function operation circuit 321 corresponds to such a circuit that is required for executing a function of the product 300 realized by the component 320. The fail-safe circuit 330 corresponds to such a circuit that stops operation of the function operation circuit 321.

In the second embodiment mode, even when the component 320 fails, although no adverse influence may be given to the safety of the product 300, the component 320 whose failure may cause the product 300 to lose the major function contains the fail-safe circuit 330. As a result, when a problem can be confirmed in the component 320, the component 320 can be intentionally brought into a failure by the fail-safe circuit 330. As a consequence, when the component 320 is brought into the failure, the product 300 can be controlled not to be operated, so that the safety when the lifetime of the product 300 is ended can be increased.

### Third Embodiment Mode

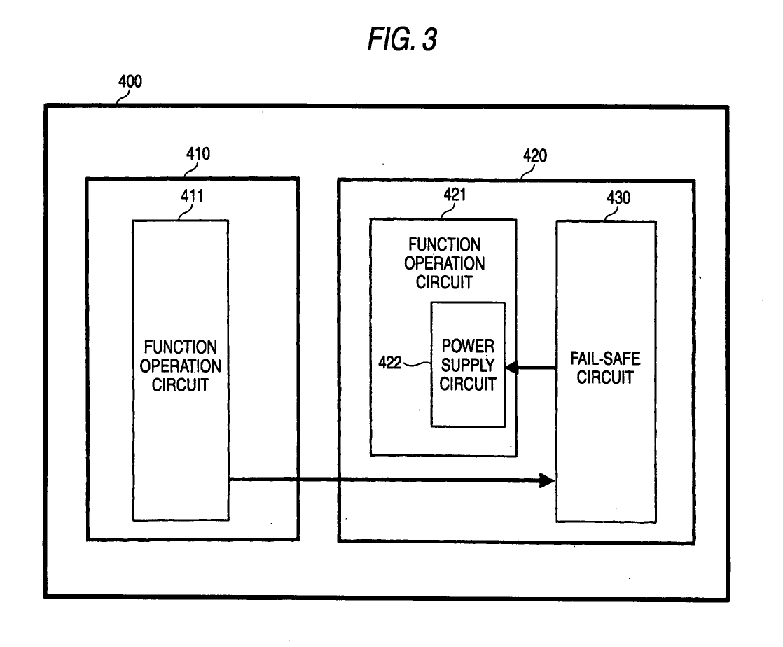

FIG. 3 is a block diagram for indicating a product having a fail-safe function, according to a third embodiment mode of the present invention. The product 400 shown in FIG. 3 is equipped with a component 410 having a function operation circuit 411, and a component 420 having a function operation circuit 421 and also a fail-safe circuit 430. The function operation circuit 421 contains thereinto a power supply circuit 422.

The component 410 corresponds to such a component whose failure may be directly coupled to a risk as to a safe aspect of the product 400. The component 420 is such a component that even when the component 420 fails, although this failure does not give an adverse influence to safety of the product 400, the failure of the component 420 causes the product 400 to lose a major function thereof. The function operation circuit 411 corresponds to such a circuit which is required for executing a function of the product 400 realized by the component 410. The function operation circuit 421 corresponds to such a circuit which is required for executing a function of the product 400 realized by the component 420. The power supply circuit 422 corresponds to a circuit which controls a supply of electric power to the function operation circuit 421, namely, such a circuit required in order that the function operation circuit 421 is operated under normal condition. The fail-safe circuit 430 corresponds to the following circuit: That is, while the fail-safe circuit 430 continuously monitors statuses of the function operation circuit 411, when the fail-safe circuit 430 detects a problem of the function operation circuit 411 due to a deterioration and the like, the fail-safe circuit 430 controls the power supply circuit 422 contained in the function operation circuit 421 so as to stop the supply of the electric power to the function operation circuit 421. It should also be noted that the fail-safe circuit 430 may be alternatively mounted outside the component 420.

In the third embodiment mode, while the fail-safe circuit 430 continuously monitors the statuses of the function operation circuit 411 contained in the component 410 whose failure may be directly coupled to the safe aspect of the product 400, when the fail-safe circuit 430 detects the problem of the function operation circuit 411, the fail-safe circuit 430 stops the operation of the function operation circuit 421. If the operation of the function operation circuit 421 is stopped, then the component 420 is not operated, but if the component 420 is not operated, then the component 410 is not also operated. As a consequence, it is possible to avoid the below-mentioned event: That is, while the failure of the component 410 is maintained whose failure may be directly coupled to the risk with respect to the safe aspect of the product 400, the product 400 is continuously operated, so that the component 410 is brought into the deterioration failure. As previously described, the safety when the lifetime of the product 400 is ended can be increased.

### Fourth Embodiment Mode

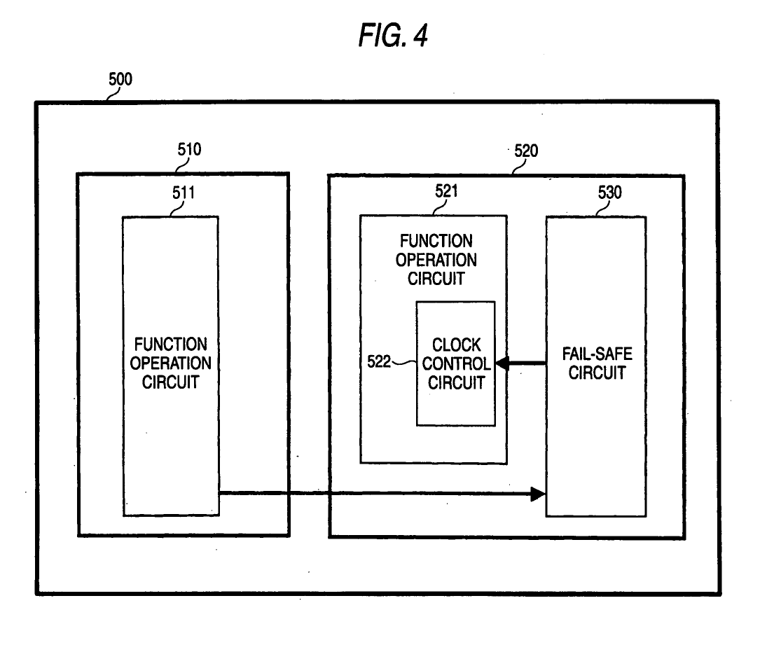

FIG. 4 is a block diagram for indicating a product having a fail-safe function, according to a fourth embodiment mode of the present invention. The product 500 shown in FIG. 4 is equipped with a component 510 having a function operation circuit 511, and a component 520 having a function operation circuit 521 and also a fail-safe circuit 530. The function operation circuit 521 contains thereinto a clock control circuit 522.

The component 510 corresponds to such a component whose failure may be directly coupled to a risk as to a safe aspect of the product 500. The component 520 is such a component that even when the component 520 fails, although this failure does not give an adverse influence to safety of the product 500, the failure of the component 520 causes the product 500 to lose a major function thereof. The function operation circuit 511 corresponds to such a circuit which is required for executing a function of the product 500 realized by the component 510. The function operation circuit 521 corresponds to such a circuit which is required for executing a function of the product 500 realized by the component 520. The clock control circuit 522 corresponds to a circuit which controls a supply of a clock signal to the function operation circuit 521, namely, such a circuit required in order that the function operation circuit 521 is operated under normal condition. The fail-safe circuit 530 corresponds to the following circuit: That is, while the fail-safe circuit 530 continuously monitors statuses of the function operation circuit 511, when the fail-safe circuit 530 detects a problem of the function operation circuit 511 due to a deterioration and the like, the fail-safe circuit 530 controls the clock control circuit 522 contained in the function operation circuit 521 so as to stop the supply of the clock signal to the function operation circuit 521. It should also be noted that the fail-safe circuit 530 may be alternatively mounted outside the component 520.

In the fourth embodiment mode, while the fail-safe circuit 530 continuously monitors the statuses of the function operation circuit 511 contained in the component 510 whose failure may be directly coupled to the safe aspect of the product 500, when the fail-safe circuit 530 detects the problem of the function operation circuit 511, the fail-safe circuit 530 stops the supply of the clock signal to the function operation circuit 521. If supplying of the clock signal to the function operation circuit 521 is stopped, then the component 520 is not operated, but if the component 520 is not operated, then the component 510 is not also operated. As a consequence, it is possible to avoid the below-mentioned event: That is, while the failure of the component 510 is maintained whose failure may be directly coupled to the risk with respect to the safe aspect of the product 500, the product 500 is continuously operated, so that the component 510 is brought into the deterioration failure. As previously described, the safety when the lifetime of the product 500 is ended can be increased.

### Fifth Embodiment Mode

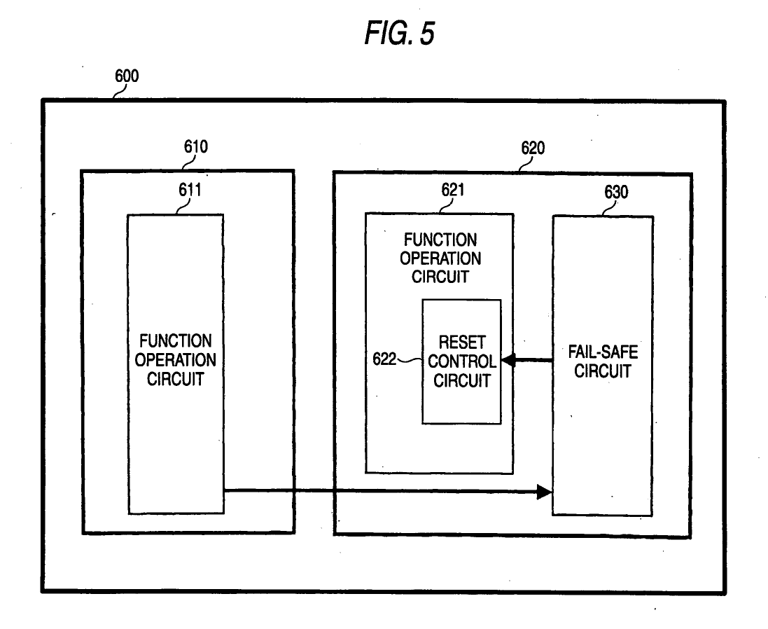

FIG. 5 is a block diagram for indicating a product having a fail-safe function, according to a fifth embodiment mode of the present invention. The product 600 shown in FIG. 5 is equipped with a component 610 having a function operation circuit 611, and a component 620 having a function operation circuit 621 and also a fail-safe circuit 630. The function operation circuit 621 contains thereinto a reset control circuit 622.

The component 610 corresponds to such a component whose failure may be directly coupled to a risk as to a safe aspect of the product 600. The component 620 is such a component that even when the component 620 fails, although this failure does not give an adverse influence to safety of the product 600, the failure of the component 610 causes the product 600 to lose a major function thereof. The function operation circuit 611 corresponds to such a circuit which is required for executing a function of the product 600 realized by the component 610. The function operation circuit 621 corresponds to such a circuit which is required for executing a function of the product 600 realized by the component 620. The reset control circuit 622 corresponds to a circuit which resets the function operation circuit 621, namely, such a circuit required in order that the function operation circuit 621 is operated under normal condition. The fail-safe circuit 630 corresponds to the following circuit: That is, while the fail-safe circuit 630 continuously monitors statuses of the function operation circuit 611, when the fail-safe circuit 630 detects a problem of the function operation circuit 611 due to a deterioration and the like, the fail-safe circuit 630 controls the reset control circuit 622 contained in the function operation circuit 621 so as to maintain such a condition that the function operation circuit 621 has been continuously reset. It should also be noted that the fail-safe circuit 630 may be alternatively mounted outside the component 620.

In the fifth embodiment mode, while the fail-safe circuit 630 continuously monitors the statuses of the function operation circuit 611 contained in the component 610 whose failure may be directly coupled to the safe aspect of the product 600, when the fail-safe circuit 630 detects the problem of the function operation circuit 611, the fail-safe circuit 630 keeps the function operation circuit 621 under reset condition. If the function operation circuit 621 is continuously kept under the reset condition, then the component 620 is not operated, but if the component 620 is not operated, then the component 610 is not also operated. As a consequence, it is possible to avoid the below-mentioned event: That is, while the failure of the component 610 is maintained whose failure may be directly coupled to the risk with respect to the safe aspect of the product 600, the product 600 is continuously operated, so that the component 610 is brought into the deterioration failure. As previously described, the safety when the lifetime of the product 600 is ended can be increased.

### Sixth Embodiment Mode

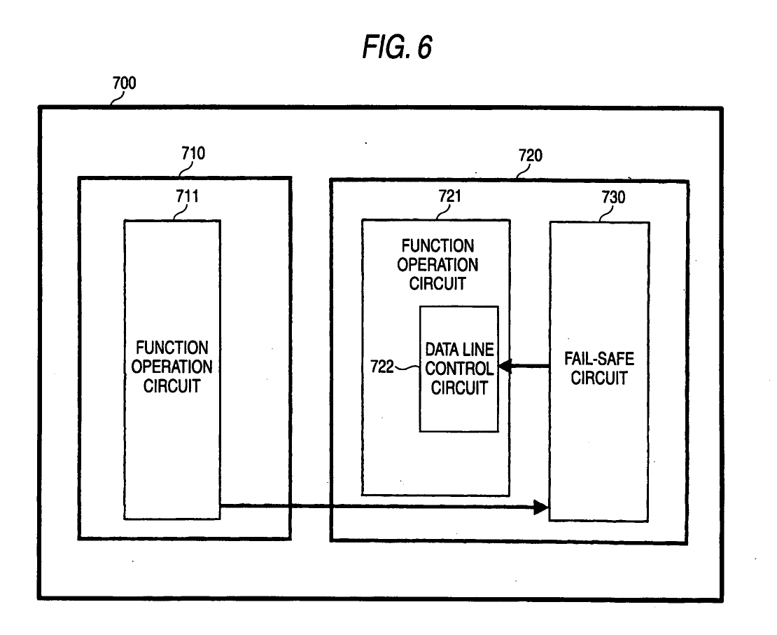

FIG. 6 is a block diagram for indicating a product having a fail-safe function, according to a sixth embodiment mode of the present invention. The product 700 shown in FIG. 6 is equipped with a component 710 having a function operation circuit 711, and a component 720 having a function operation circuit 721 and also a fail-safe circuit 730. The function operation circuit 721 contains thereinto a data line control circuit 722.

The component 710 corresponds to such a component whose failure may be directly coupled to a risk as to a safe aspect of the product 700. The component 720 is such a component that even when the component 720 fails, although this failure does not give an adverse influence to safety of the product 700, the failure of the component 720 causes the product 700 to lose a major function thereof. The function operation circuit 711 corresponds to such a circuit which is required for executing a function of the product 700 realized by the component 710. The function operation circuit 721 corresponds to such a circuit which is required for executing a function of the product 700 realized by the component 720. The clock control circuit 722 corresponds to a circuit which controls a supply of a clock signal to the function operation circuit 721, namely, such a circuit required in order that the function operation circuit 721 is operated under normal condition. The fail-safe circuit 730 corresponds to the following circuit: That is, while the fail-safe circuit 730 continuously monitors statuses of the function operation circuit 711, when the fail-safe circuit 730 detects a problem of the function operation circuit 711 due to a deterioration and the like, the fail-safe circuit 730 controls the data line control circuit 722 contained in the function operation circuit 721 so as to bring the data line of the function operation circuit 721 into an uncontrolled condition. It should also be noted that the fail-safe circuit 730 may be alternatively mounted outside the component 720.

In the sixth embodiment mode, while the fail-safe circuit 730 continuously monitors the statuses of the function operation circuit 711 contained in the component 710 whose failure may be directly coupled to the safe aspect of the product 700, when the fail-safe circuit 730 detects the problem of the function operation circuit 711, the fail-safe circuit 730 brings the data line of the function operation circuit 721 into the uncontrolled condition. If the data line of the function operation circuit 721 is brought into the uncontrolled condition, then the component 720 is not operated, but if the component 720 is not operated, then the component 710 is not also operated. As a consequence, it is possible to avoid the below-mentioned event: That is, while the failure of the component 710 is maintained whose failure may be directly coupled to the risk with respect to the safe aspect of the product 700, the product 700 is continuously operated, so that the component 710 is brought into the deterioration failure. As previously described, the safety when the lifetime of the product 700 is ended can be increased.

### Seventh Embodiment Mode

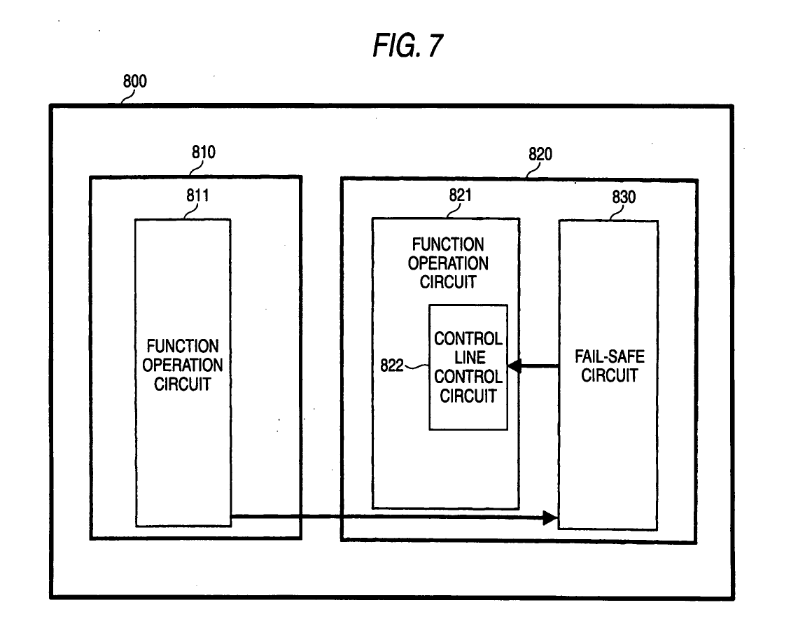

FIG. 7 is a block diagram for indicating a product having a fail-safe function, according to a seventh embodiment mode of the present invention. The product 800 shown in FIG. 7 is equipped with a component 810 having a function operation circuit 811, and a component 820 having a function operation circuit 821 and also a fail-safe circuit 830. The function operation circuit 821 contains thereinto a control line control circuit 822.

The component 810 corresponds to such a component whose failure may be directly coupled to a risk as to a safe aspect of the product 800. The component 820 is such a component that even when the component 820 fails, although this failure does not give an adverse influence to safety of the product 800, the failure of the component 820 causes the product 800 to lose a major function thereof. The function operation circuit 811 corresponds to such a circuit which is required for executing a function of the product 800 realized by the component 810. The function operation circuit 821 corresponds to such a circuit which is required for executing a function of the product 800 realized by the component 820. The control line control circuit 822 corresponds to a circuit which controls a control line of the function operation circuit 821, namely, such a circuit required in order that the function operation circuit 821 is operated under normal condition. The fail-safe circuit 830 corresponds to the following circuit: That is, while the fail-safe circuit 830 continuously monitors statuses of the function operation circuit 811, when the fail-safe circuit 830 detects a problem of the function operation circuit 811 due to a deterioration and the like, the fail-safe circuit 830 controls the control line control circuit 822 contained in the function operation circuit 821 so as to bring the control line of the function operation circuit 821 into an uncontrolled condition. It should also be noted that the fail-safe circuit 830 may be alternatively mounted outside the component 820.

In the seventh embodiment mode, while the fail-safe circuit 830 continuously monitors the statuses of the function operation circuit 811 contained in the component 810 whose failure may be directly coupled to the safe aspect of the product 800, when the fail-safe circuit 830 detects the problem of the function operation circuit 811, the fail-safe circuit 830 brings the control line of the function operation circuit 821 into the uncontrolled condition. If the fail-safe circuit 830 brings the control line of the function operation circuit 821 into the uncontrolled condition, then the component 820 is not operated, but if the component 820 is not operated, then the component 810 is not also operated. As a consequence, it is possible to avoid the below-mentioned event: That is, while the failure of the component 810 is maintained whose failure may be directly coupled to the risk with respect to the safe aspect of the product 800, the product 800 is continuously operated, so that the component 810 is brought into the deterioration failure. As previously described, the safety when the lifetime of the product 800 is ended can be increased.

### Eighth Embodiment Mode

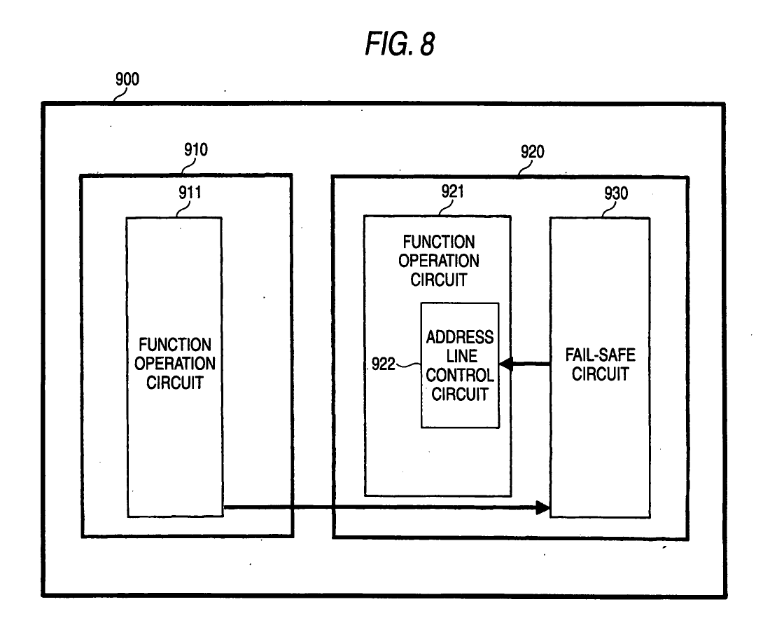

FIG. 8 is a block diagram for indicating a product having a fail-safe function, according to an eighth embodiment mode of the present invention. The product 900 shown in FIG. 8 is equipped with a component 910 having a function operation circuit 911, and a component 920 having a function operation circuit 921 and also a fail-safe circuit 930. The function operation circuit 921 contains thereinto an address line control circuit 922.

The component 910 corresponds to such a component whose failure may be directly coupled to a risk as to a safe aspect of the product 900. The component 920 is such a component that even when the component 920 fails, although this failure does not give an adverse influence to safety of the product 900, the failure of the component 920 causes the product 900 to lose a major function thereof. The function operation circuit 911 corresponds to such a circuit which is required for executing a function of the product 900 realized by the component 910. The function operation circuit 921 corresponds to such a circuit which is required for executing a function of the product 900 realized by the component 920. The address line control circuit 922 corresponds to a circuit which controls an address line of the function operation circuit 921, namely, such a circuit required in order that the function operation circuit 921 is operated under normal condition. The fail-safe circuit 930 corresponds to the following circuit: That is, while the fail-safe circuit 930 continuously monitors statuses of the function operation circuit 911, when the fail-safe circuit 930 detects a problem of the function operation circuit 911 due to a deterioration and the like, the fail-safe circuit 930 controls the address line control circuit 922 contained in the function operation circuit 921 so as to bring the address line of the function operation circuit 921 into an uncontrolled condition. It should also be noted that the fail-safe circuit 930 may be alternatively mounted outside the component 920.

In the eighth embodiment mode, while the fail-safe circuit 930 continuously monitors the statuses of the function operation circuit 911 contained in the component 910 whose failure may be directly coupled to the safe aspect of the product 900, when the fail-safe circuit 930 detects the problem of the function operation circuit 911, the fail-safe circuit 930 brings the address line of the function operation circuit 921 into the uncontrolled condition. If the fail-safe circuit 930 brings the address line of the function operation circuit 921 into the uncontrolled condition, then the component 920 is not operated, but if the component 920 is not operated, then the component 910 is not also operated. As a consequence, it is possible to avoid the below-mentioned event: That is, while the failure of the component 910 is maintained whose failure may be directly coupled to the risk with respect to the safe aspect of the product 900, the product 900 is continuously operated, so that the component 910 is brought into the deterioration failure. As previously described, the safety when the lifetime of the product 900 is ended can be increased.

### Ninth Embodiment Mode

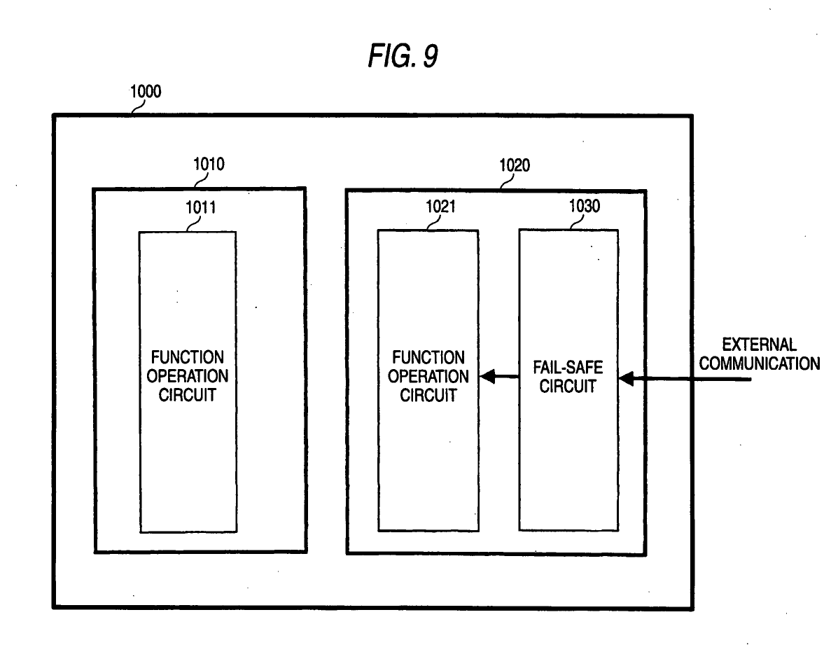

FIG. 9 is a block diagram for indicating a product having a fail-safe function, according to a ninth embodiment mode of the present invention. The product 1000 shown in FIG. 9 is equipped with a component 1010 having a function operation circuit 1011, and a component 1020 having a function operation circuit 1021 and also a fail-safe circuit 1030.

The component 1010 corresponds to such a component whose failure may be directly coupled to a risk as to a safe aspect of the product 1000. The component 1020 is such a component that even when the component 1020 fails, although this failure does not give an adverse influence to safety of the product 1000, the failure of the component 1020 causes the product 1000 to lose a major function thereof. The function operation circuit 1011 corresponds to such a circuit which is required for executing a function of the product 1000 realized by the component 1010. The function operation circuit 1021 corresponds to such a circuit which is required for executing a function of the product 1000 realized by the component 1020. The fail-safe circuit 1030 corresponds to the following circuit: That is, while the fail-safe circuit 1030 detects statuses of the function operation circuit 1011 in response to an operation inputted from an external unit via a network such as the Internet and the like, when the fail-safe circuit 1030 detects a problem of the function operation circuit 1011 due to a deterioration and the like, the fail-safe circuit 1030 stops the operation of the function operation circuit 1021. It should also be understood that after the fail-safe circuit 1030 has detected the problem of the function operation circuit 1011, when the fail-safe circuit 1030 receives an instruction signal for stopping the operation of the function operation circuit 1021 via the network, the fail-safe circuit 1021 may alternatively stop the operation of the function operation circuit 1021 in response to this instruction signal. It should also be noted that the fail-safe circuit 1030 may be alternatively mounted outside the component 1020.

In the ninth embodiment mode, the component 1020 contains thereinto the fail-safe circuit 1030, while even when the component 1020 fails, although the failure of the component 1020 does not give the adverse influence to the safety of the product 1000, this failure of the component 1020 causes the product 1000 to lose the major function thereof. As a result, when the fail-safe circuit 1030 confirms a problem in the component 1010, the fail-safe circuit 1030 can stop the operation of the function operation circuit 1021. As a consequence, it is possible to avoid the below-mentioned event: That is, while the failure of the component 1010 is maintained whose failure may be directly coupled to the risk with respect to the safe aspect of the product 1000, the product 1000 is continuously operated, so that the component 1010 is brought into the deterioration failure. As previously described, the safety when the lifetime of the product 1000 is ended can be increased.

### Tenth Embodiment Mode

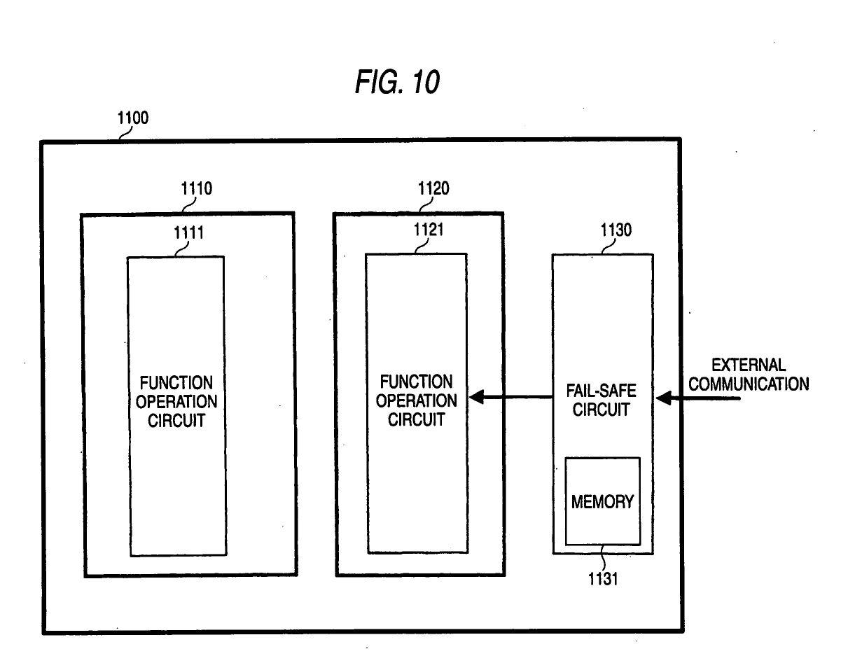

FIG. 10 is a block diagram for indicating a product having a fail-safe function, according to a tenth embodiment mode of the present invention. The product 1100 shown in FIG. 10 is equipped with a component 1110 having a function operation circuit 1111, a component 1120 having a function operation circuit 1121, and a fail-safe circuit 1130.

The component 1110 corresponds to such a component whose failure may be directly coupled to a risk as to a safe aspect of the product 1100. The component 1120 is such a component that even when the component 1120 fails, although this failure does not give an adverse influence to safety of the product 1100, the failure of the component 1120 causes the product 1100 to lose a major function thereof. The function operation circuit 1111 corresponds to such a circuit which is required for executing a function of the product 1100 realized by the component 1120. The function operation circuit 1121 corresponds to such a circuit which is required for executing a function of the product 1100 realized by the component 1120. The fail-safe circuit 1130 contains a memory 1131 which stores thereinto such a day/time information as a purchase day/time, an initial operation day/time, or the like. The fail-safe circuit 1130 corresponds to a circuit which stops the operation of the function operation circuit 1121 when a predetermined time period has passed from the day and time indicated by the day/time information stored in the memory 1131. Alternatively, when the fail-safe circuit 1130 receives an instruction signal for stopping the operation of the function operation circuit 1121 via a network after the predetermined time period has passed from the day and time indicated by the day/time information, the fail-safe circuit 1130 may stop the operation of the function operation circuit 1121 in response to the received instruction signal. It should also be noted that the fail-safe circuit 1130 may be alternatively mounted inside the component 1120.

In the tenth embodiment mode, when the predetermined time period has elapsed after the product 1100 was purchased, or was operated as the initial operation, the operation of the function operation circuit 1121 of such a component 1120 is stopped by the fail-safe circuit 1130. Even when the above-described component 1120 fails, although the failure of the component 1120 does not give the adverse influence to the safety of the product 1100, this failure of the component 1120 may cause the product 1100 to lose the major function. Normally, as to failure rates after a predetermined time has elapsed, it has been so designed that the failure rate of the component 1110 is lower than the failure rate of the component 1120. As a consequence, it is possible to avoid the following event: That is, the product 1100 is continuously operated for a long time period which has exceeded the predetermined time, so that the component 1110 is brought into the deterioration failure. As previously described, the safety when the lifetime of the product 1100 is ended can be increased.

### Eleventh Embodiment Mode

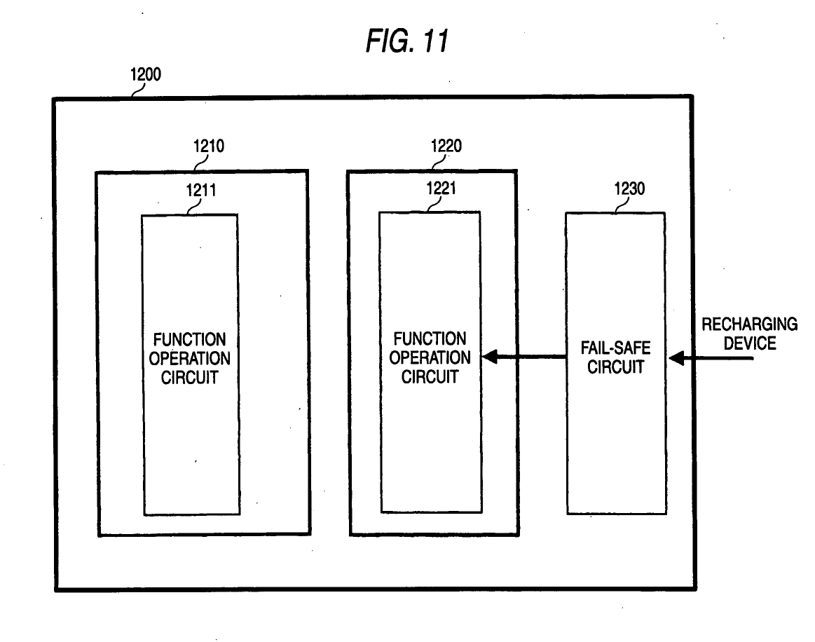

FIG. 11 is a block diagram for indicating a product having a fail-safe function, according to an eleventh embodiment mode of the present invention. The product 1200 shown in FIG. 11 is equipped with a component 1210 having a function operation circuit 1211, a component 1220 having a function operation circuit 1221, and a fail-safe circuit 1230. In this eleventh embodiment mode, day/time information such as purchase information, or initial operation day and time has been stored in a memory (not shown) built in a recharging device (not shown) which is employed so as to charge the product 1200.

The component 1210 corresponds to such a component whose failure may be directly coupled to a risk as to a safe aspect of the product 1200. The component 1220 is such a component that even when the component 1220 fails, although this failure does not give an adverse influence to safety of the product 1200, the failure of the component 1220 causes the product 1200 to lose a major function thereof. The function operation circuit 1211 corresponds to such a circuit which is required for executing a function of the product 1200 realized by the component 1220. The function operation circuit 1221 corresponds to such a circuit which is required for executing a function of the product 1200 realized by the component 1220. The fail-safe circuit 1230 corresponds to such a circuit which stops operation of the function operation circuit 1221 when a predetermined time period has elapsed from the day and time indicated by the day/time information stored in the memory of the externally provided recharging device. Alternatively, when the fail-safe circuit 1230 receives an instruction signal for stopping the operation of the function operation circuit 1221 via a network after the predetermined time period has passed from the day and time indicated by the day/time information, the fail-safe circuit 1230 may stop the operation of the function operation circuit 1221 in response to the received instruction signal. It should also be noted that the fail-safe circuit 1230 may be alternatively mounted inside the component 1220.

In the eleventh embodiment mode, when the predetermined time period has elapsed after the product 1200 was purchased, or was operated as the initial operation, the operation of the function operation circuit 1221 of such a component 1220 is stopped by the fail-safe circuit 1230. Even when the above-described component 1220 fails, although the failure of the component 1220 does not give the adverse influence to the safety of the product 1200, this failure of the component 1220 may cause the product 1200 to lose the major function. Normally, as to failure rates after a predetermined time has elapsed, it has been so designed that the failure rate of the component 1210 is lower than the failure rate of the component 1220. As a consequence, it is possible to avoid the following event: That is, the product 1200 is continuously operated for a long time period which has exceeds the predetermined time, so that the component 1210 is brought into the deterioration failure. As previously described, the safety when the lifetime of the product 1200 is ended can be increased.

The electronic appliance related to the present invention is useful as such an electronic appliance which is equipped with a component whose failure may be directly coupled to a risk with respect to a safe aspect of the electronic appliance, and another component, while even when the last-mentioned component fails, although this failure does not give an adverse influence to safety of the electronic appliance, the failure of this component causes the electronic appliance to lose a major function thereof, while safety of the electronic appliance is furthermore improved when a lifetime thereof is ended.

What is claimed is:

1. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof; and
a fail-safe circuit for stopping operation of said second component.

2. The electronic appliance as claimed in claim 1, wherein:
said fail-safe circuit is provided within said second component.

3. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
a power supply circuit for controlling a supply of electric power to said second component; and
a fail-safe circuit operated in such a manner that while said fail-safe circuit monitors a status of said first component, when said fail-safe circuit detects a problem of said first component, said fail-safe circuit controls said power supply circuit so as to stop the supply of the electric power to said second component.

4. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
a clock control circuit for controlling a clock signal supplied to said second component; and
a fail-safe circuit operated in such a manner that while said fail-safe circuit monitors a status of said first component, when said fail-safe circuit detects a problem of said first component, said fail-safe circuit controls said clock control circuit so as to stop the supply of the clock signal to said second component.

5. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
a reset control circuit for resetting said second component; and
a fail-safe circuit operated in such a manner that while said fail-safe circuit monitors a status of said first component, when said fail-safe circuit detects a problem of said first component, said fail-safe circuit controls said reset control circuit in order that said second component is kept under a resetting condition thereof.

6. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
a data line control circuit for controlling a data line of said second component; and
a fail-safe circuit operated in such a manner that while said fail-safe circuit monitors a status of said first component, when said fail-safe circuit detects a problem of said first component, said fail-safe circuit controls said data line control circuit in order that the data line of said second component is brought into an uncontrolled condition.

7. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
a control line control circuit for controlling a control line of said second component; and
a fail-safe circuit operated in such a manner that while said fail-safe circuit monitors a status of said first component, when said fail-safe circuit detects a problem of said first component, said fail-safe circuit controls said control line control circuit in order that the control line of said second component is brought into an uncontrolled condition.

8. An electronic appliance, comprising:
a first component whose failure is directly coupled to a risk with respect to a safe aspect of said electronic appliance;
a second component by which even when said second component fails, although the failure of the second component does not give an adverse influence to safety of said electronic appliance, the failure of said second component causes said electronic appliance to lose a major function thereof;
an address line control circuit for controlling an address line of said second component; and
a fail-safe circuit operated in such a manner that while said fail-safe circuit monitors a status of said first component, when said fail-safe circuit detects a problem of said first component, said fail-safe circuit controls said address line control circuit in order that said the address line of said second component is brought into an uncontrolled condition.

9. The electronic appliance as claimed in claim 1, wherein:
when said fail-safe circuit detects a status of said first component in response to a signal transmitted from an external appliance and detects a problem of said first component, said fail-safe circuit stops the operation of said second component.

10. The electronic appliance as claimed in claim 9, wherein:
after said fail-safe circuit has detected the problem of the first component, when the fail-safe circuit receives an instruction signal for stopping the operation of said second component transmitted from said external appliance, said fail-safe circuit stops the operation of said second component.

11. The electronic appliance as claimed in claim 9, wherein:
the signal transmitted from said external appliance is a signal transferred therefrom via a network.

12. The electronic appliance as claimed in claim 1, wherein:
when a predetermined time has elapsed from a time indicated by time information related to a purchase of said electronic appliance, or an initial operation of said electronic appliance, said fail-safe circuit stops the operation of said second component.

13. The electronic appliance as claimed in claim 12, wherein: after said predetermined time has passed, when the fail-safe circuit receives an instruction signal for stopping the operation of said second component transmitted from an external appliance, said fail-safe circuit stops the operation of said second component.

14. The electronic appliance as claimed in claim 13, wherein said external appliance is a recharging device of said electronic appliance.
